(19) United States
(12) Patent Application Publication
(10) Pub. No.: US 2012/0032656 A1
(43) Pub. Date: Feb. 9, 2012

(54) VOLTAGE REGULATOR FOR IMPEDANCE MATCHING AND PRE-EMPHASIS, METHOD OF REGULATING VOLTAGE FOR IMPEDANCE MATCHING AND PRE-EMPHASIS, VOLTAGE MODE DRIVER INCLUDING THE VOLTAGE REGULATOR, AND VOLTAGE-MODE DRIVER USING THE METHOD

(75) Inventors: Chun Jung Hoon, Seoul-si (KR); Kwon Kee Won, Seongnam-si (KR); Song Jong Hyun, Jangan-gu (KR); Jeon Jae Wook, Suwon-si (KR); Kim Seok, Suwon-si (KR)

(73) Assignee: SUNGKYUNKWAN UNIVERSITY FOUNDATION FOR CORPORATE COLLABORATION, Suwon-si (KR)

(21) Appl. No.: 13/176,008

(22) Filed: Jul. 5, 2011

(30) Foreign Application Priority Data
Aug. 4, 2010 (KR) 10-2010-0075334

(51) Int. Cl. G05F 1/10

(52) U.S. Cl. 323/268

(57) ABSTRACT

Disclosed herein are a voltage regulator for impedance matching and pre-emphasis, a method of regulating voltage for impedance matching and pre-emphasis, and a voltage mode driver using the voltage regulator and the method. The voltage regulator includes a first loop circuit configured to regulate a supply voltage for a pre-driver of a main tap, a second loop circuit configured to regulate a supply voltage for a pre-driver of a pre-emphasis tap, and a driver voltage determination unit configured to include a reference resistor and to determine supply voltage for the voltage mode driver. The first loop circuit includes a variable resistor, a first main tap replica, and a first OP amp, and the second loop circuit includes a resistor having a resistance value identical to that of the reference resistor of the voltage regulator, a second main tap replica, a pre-emphasis tap replica, and a second OP amp.

### CROSS-REFERENCE TO RELATED APPLICATION

This application claims priority to and the benefit of Korean Patent Application No. 10-2010-0075334 filed in the Korean Intellectual Property Office on Aug. 4, 2010, the entire contents of which are incorporated herein by reference.

### BACKGROUND OF THE INVENTION

1. Field of the Invention

The present invention relates generally to a voltage regulator and a method of regulating voltage used in a voltage mode driver. More particularly, the present invention relates to a voltage regulator and a method of regulating voltage for impedance matching and pre-emphasis and to a voltage mode driver using the voltage regulator and the method of regulating voltage.

2. Description of the Related Art

In a digital device, a transmitter functions to convert digital data, composed of ‘0’ and/or ‘1’, into voltage or current in order to send the digital data to another chip. A driver for converting data into voltage is referred to as a voltage mode driver, and a driver for converting data into current is referred to as a current mode driver.

A current mode driver easily regulates the swing of a signal by controlling current passing through a termination resistor. However, a voltage mode driver shown in FIG. 1 requires an additional voltage regulator for regulating the swing of a signal and eliminating noise input from a signal line. The voltage mode driver is being used in low-power applications despite the above disadvantage because it is advantageous in terms of power consumption.

A conventional voltage regulator requires redundant driver segments in each tap in order to adjust the number of the turned-on segments and keep output impedance identical to the characteristic resistance of a channel when it regulates the weight of the tap while taking into account the characteristics of the channel.

In this case, there are problems in that there is additional power consumption and complexity is added to the design process because unused circuits act as unnecessary overhead in devices that require high-speed processing.

This method is problematic in that the resolution of a tap is restricted by the strength of a unit driver.

Moreover, the conventional voltage mode driver is problematic in that it is difficult to implement pre-emphasis for compensating for an Inter-Symbol Interference (ISI) effect because it is difficult to finely tune the tap weights while keeping the output impedance unaltered.

### SUMMARY OF THE INVENTION

According to an aspect of the present invention, there is provided a voltage regulator of a voltage mode driver, including a first loop circuit configured to regulate a supply voltage for a pre-driver of a main tap; a second loop circuit configured to regulate a supply voltage for a pre-driver of a pre-emphasis tap; and a driver voltage determination unit configured to include a reference resistor Runit and to determine supply voltage Vd for the voltage mode driver; wherein the first loop circuit comprises a variable resistor, a first main tap replica, and a first OP amp, and the second loop circuit comprises a resistor having a resistance value identical to that of the reference resistor Runit of the voltage regulator, a second main tap replica, a pre-emphasis tap replica, and a second OP amp; wherein each of the first main tap replica, the second main tap replica, and the pre-emphasis tap replica comprises two NMOS transistors.

The driver voltage determination unit may select a reference current Is expressed by the following Equation in order to regulate the supply voltage Vd:

$${I}_{s} = \frac{{V}_{d}}{{R}_{unit}}$$

The supply voltage for the pre-driver of the main tap, which is regulated by the first loop circuit, may be regulated to a gate voltage at which the variable resistor and the two NMOS transistors of the first main tap replica have an identical resistance value in the first loop circuit to which the selected reference current Is has been applied.

The regulation to the gate voltage may be performed in such a way that the first OP amp compares voltage supplied to the variable resistor with voltage supplied to the first main tap replica using a feedback operation and then regulation is performed such that the variable resistor and the two NMOS transistors of the first main tap replica have the identical resistance value.

When the resistance value of the variable resistor decreases, the supply voltage for the pre-driver of the main tap may increase and conductance of the first main tap replica may increase.

The second main tap replica may be connected to the first main tap replica and have a resistance value identical to that of the first main tap replica, and the second main tap replica and the pre-emphasis tap replica may be connected in parallel.

The supply voltage for the pre-driver of the pre-emphasis tap, which is regulated by the second loop circuit, may be regulated to a gate voltage at which the NMOS transistors of the second main tap replica and the pre-emphasis tap replica have a resistance value identical to that of the reference resistor Runit in the second loop circuit to which the selected reference current Is has been applied.

The gate voltage may be regulated in such a way that the second OF amp compares voltage supplied to the second main tap replica and the pre-emphasis tap replica with voltage supplied to a resistor having a resistance value identical to the reference resistor Runit using a feedback operation of and then regulation is performed such that the NMOS transistors of the second main tap replica and the pre-emphasis tap replica have a resistance value identical to that of the reference resistor Runit.

According to another aspect of the present invention, there is provided a voltage mode driver including a voltage regulator, including the voltage regulator for impedance matching and pre-emphasis, set forth in any one of claims 1 to 8; at least one main tap; and a plurality of pre-emphasis taps.

The weight of the main tap may be controlled using a variable resistor and a first main tap replica of a first loop circuit.

The second loop circuit may control the weight of the pre-emphasis tap using a second main tap replica and a pre-emphasis tap replica.

The at least one main tap and the plurality of pre-emphasis taps may be connected in parallel, and the total resistance value of the at least one main tap and the plurality of pre-emphasis taps is identical to a resistance value of a reference resistor Runit of the voltage regulator.

According to another aspect of the present invention, there is provided a method for impedance matching and pre-emphasis of a voltage mode driver using a voltage regulator set forth in claim 1, including step S1 of the voltage regulator determining supply voltage for the voltage mode driver by determining a reference current Is and a reference resistance of a reference resistor Runit; step S2 of a first loop circuit to which the reference current Is determined at step S1 has been applied determining a resistance value of a variable resistor; step S3 of the first loop circuit to which the reference current Is determined at step S1 has been applied regulating supply voltage for a pre-driver of a main tap to a gate voltage at which the variable resistor and two NMOS transistors of a first main tap replica have an identical resistance value; and step S4 of, in a state in which a second main tap replica and a pre-emphasis tap replica of a second loop circuit are connected in parallel, the second loop circuit to which the reference current Is determined at step S1 has been applied regulating supply voltage for a pre-driver of a pre-emphasis tap to a gate voltage at which a total resistance value of the pre-emphasis tap replica and the second main tap replica to which the gate voltage determined at step S3 has been applied is identical to the resistance value of the reference resistor Runit.

The resistance value of the variable resistor at step S2 may be determined using a parallel switch.

Step S3 may include a first OP amp comparing voltage supplied to the variable resistor with voltage supplied to a first main tap replica using a feedback operation and then regulation being performed to reach the gate voltage at which the variable resistor and two NMOS transistors of the first main tap replica have an identical resistance value.

Step S4 comprises a second OP amp comparing voltage supplied to the second main tap replica and the pre-emphasis tap replica with voltage supplied to a resistor having a resistance value identical to that of the reference resistor Runit using a feedback operation and then regulation being performed to reach the gate voltage at which the total resistance value of all NMOS transistors of the second main tap replica and the pre-emphasis tap replica is identical to the resistance value of the reference resistor Runit.

According to another aspect of the present invention, there is provided a voltage mode driver including a voltage regulator including the voltage regulator for performing the method of regulating voltage for impedance matching and pre-emphasis, set forth in any one of claims 13 to 16; at least one main tap; and a plurality of pre-emphasis taps.

The weight of the main tap may be controlled using a variable resistor and a first main tap replica of the first loop circuit.

The second loop circuit may control the weight of the pre-emphasis tap using a second main tap replica and a pre-emphasis tap replica.

The at least one main tap and the plurality of pre-emphasis taps may be connected in parallel, and the total resistance value of the at least one main tap and the plurality of pre-emphasis taps may be identical to the resistance value of a reference resistor Runit of the voltage regulator.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a typical circuit diagram of a voltage mode driver;

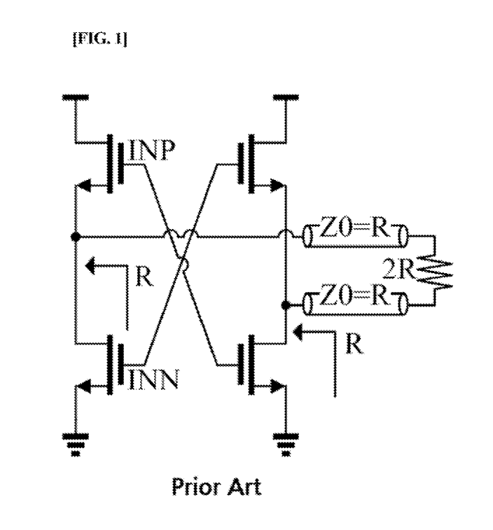

FIG. 2 is an enlarged diagram showing the structure of a voltage mode transmission driver and a single unit driver circuit;

FIG. 3 is a circuit diagram of a voltage regulator according to the present invention; and

FIG. 4 is a flowchart schematically illustrating a method of regulating voltage for impedance matching and pre-emphasis according to the present invention.

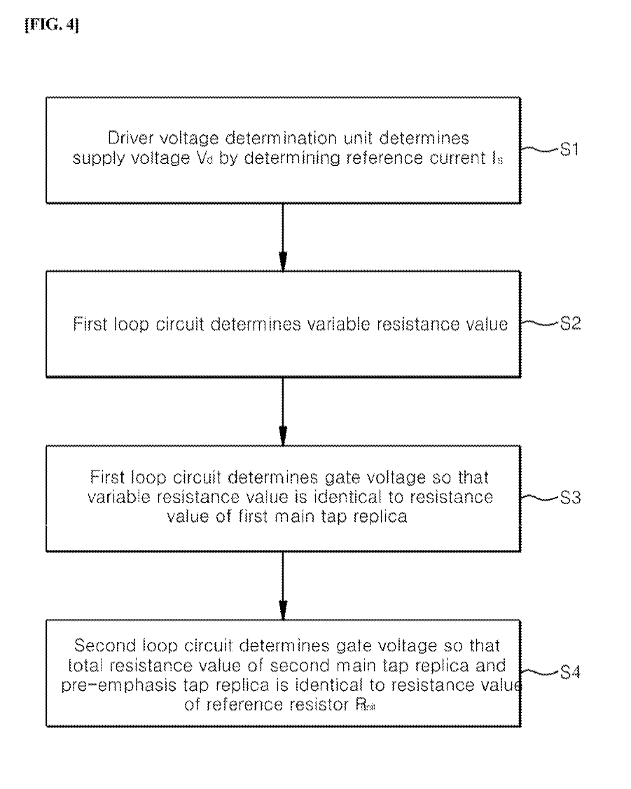

### DESCRIPTION OF THE PREFERRED EMBODIMENTS

A voltage regulator for impedance matching and pre-emphasis, a method of regulating voltage for impedance matching and pre-emphasis, a voltage mode driver including the voltage regulator, and a voltage mode driver using the method of regulating voltage will be described in detail with reference to the accompanying drawings.

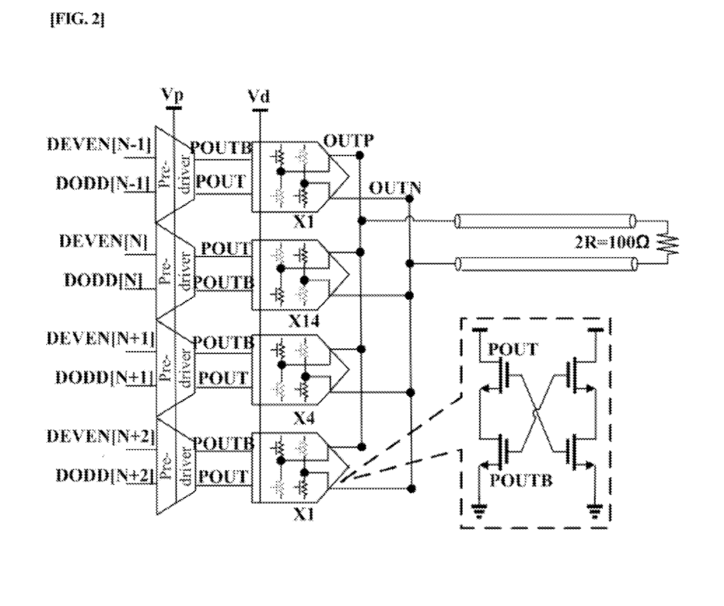

FIG. 2 shows the structure of a voltage mode transmission driver. In an embodiment of the present invention, the voltage mode transmission driver may have four tap Finite Impulse Response (FIR) filters for compensating for the ISI effect.

OUTP and OUTN shown in FIG. 2 denote output signals at the final stage, and POUT and POUTB denote signals that are input to the input terminals of the voltage mode transmission driver via pre-drivers.

DEVEN and DODD denote data flows that are input to the input terminals of the pre-drivers. The pre-driver to which data flows, denoted by DEVEN[N] and DODD[N], are input is connected to a main driver.

X1, X4, etc. denote the segment numbers of respective driver stages, and roughly indicate tap weight ratios. For example, FIG. 2 shows an embodiment in which a main tap is composed of 14 segments. The number of segments existing in the voltage mode transmission driver may vary depending on the characteristics of each channel, and some of a plurality of segments may be selectively used by electrical manipulation.

The voltage mode transmission driver of FIG. 2 includes a main driver and three pre-emphasis drivers. One of the three pre-emphasis drivers is used for bits after the signal of the main tap, and the remaining two pre-emphasis drivers are used for data before the signal of the main tap.

Since a Double Data Rate (DDR) signal is used, two data flows DEVEN and DODD are input.

FIG. 2 also shows an enlarged diagram of a unit driver. The unit driver is a push-pull driver in an NMOS-over-NMOS form. NMOS transistors included in the unit driver are located in a triode region because the regulated supply voltage is low (i.e., about 300 mV). The NMOS transistors, forming the voltage mode driver to which low voltage is supplied, function as resistors only when they are driven in the triode region.

Accordingly, the NMOS transistors are configured like pull-up and pull-down resistors. The pull-up or pull-down resistor is always connected to an output node OUT. Consequently, the impedance of the output node OUT is always maintained at 50Ω regardless of the configuration of the four taps.

When data is transmitted over a transmission line at a high data rate, ISI occurs due to the characteristics of the transmission line. ISI severely distorts the swing and phase of a received signal and becomes a major cause of bit error at the receiving end. With increases in the length of the transmission line and the data transfer rate, the swing and phase of a signal received at the receiving end are further distorted.

In order to compensate for distortion attributable to ISI, equalization is performed in a receiver.

In order to reduce the ISI of a signal received at the receiving end, a transmitter may regulate the strength of pre-emphasis in accordance with transmission conditions, such as the length of the transmission line and the transfer rate, and then send a signal. Since a high frequency component is more attenuated than a low frequency component over the transmission line, the transmitting end emphasizes data corresponding to a high frequency component and then sends the emphasized data.

The present invention is configured to implement pre-emphasis in the voltage mode transmission driver while improving resolution by regulating gate voltage for a main tap driver and a pre-emphasis tap driver.

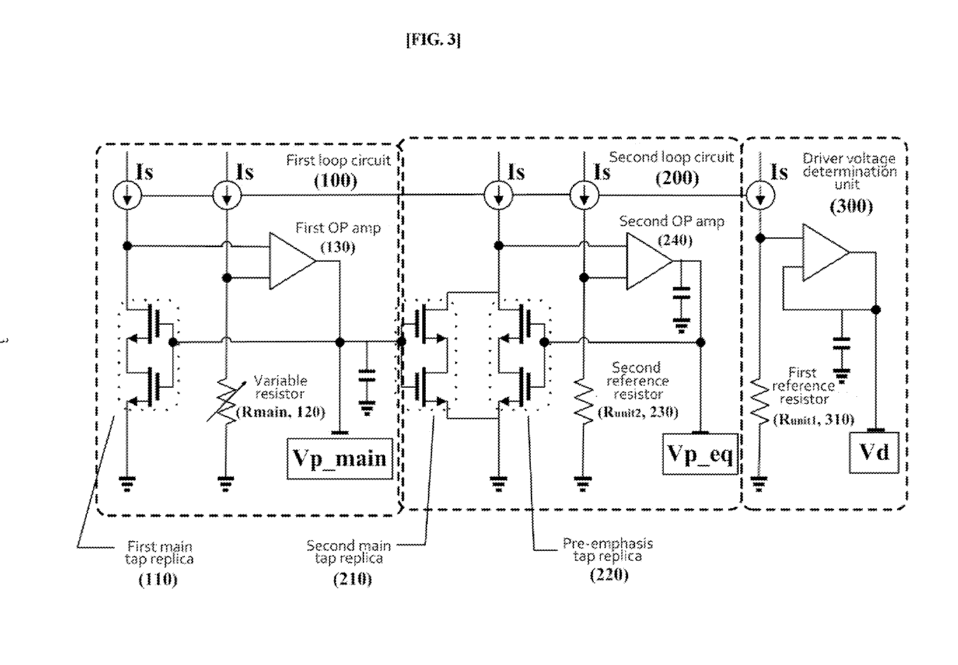

FIG. 3 shows the configuration of a voltage regulator of the present invention which is used in a voltage mode driver.

The voltage regulator for impedance matching and pre-emphasis according to the present invention includes a first loop circuit 100 configured to regulate supply voltage for the pre-driver of a main tap, a second loop circuit 200 configured to regulate supply voltage for the pre-driver of a pre-emphasis tap, and a driver voltage determination unit 300 configured to include a first reference resistor Runit1 310 and to determine supply voltage Vd for all the drivers.

As a result, the first loop circuit 100 for regulating supply voltage for the pre-driver of the main tap regulates gate voltage for the main driver. The second loop circuit 200 for regulating supply voltage for the pre-driver of the pre-emphasis tap regulates gate voltage for the pre-emphasis driver.

The first loop circuit 100 includes a variable resistor Rmain 120, a first main tap replica 110, and a first OP amp 130. The second loop circuit 200 includes a second resistor Runit2 230 having the same value as the first reference resistor Runit1 310 of the driver voltage determination unit 300, a second main tap replica 210, a pre-emphasis tap replica 220, and a second OP amp 240.

Furthermore, each of the first main tap replica 110, the second main tap replica 210, and the pre-emphasis tap replica 220 includes two NMOS transistors.

As is well known, the purpose of a pre-emphasis process using the main tap and the pre-emphasis tap is to emphasize data by superimposing the target portions of a main signal on each other. Since the details of the pre-emphasis process are known to those skilled in the art, a description thereof will be omitted here.

In the present invention, how the weight for the main tap and the pre-emphasis tap for pre-emphasis is controlled is essential.

First, the driver voltage determination unit 300 selects a reference current Is expressed by the following Equation 1 in order to regulate the supply voltage Vd. The supply voltage Vd is voltage that is supplied to a voltage mode driver.

$${I}_{s} = \frac{{V}_{d}}{{R}_{unit}}$$

In Equation 1, Vᵢ is voltage supplied to the voltage mode driver, Rᵤₙᵢₜ is reference resistance, and Iᵢ is reference current supplied to the voltage regulator. Since the reference resistor Rᵤₙᵢₜ is previously set, the supply voltage Vᵢ is determined depending on the reference current Iᵢ applied to the voltage regulator. Here, the reference resistance is called Runit1 because it is the reference resistance of the driver voltage determination unit 300.

An apparatus for supplying the determined reference current may be located outside or inside the voltage regulator.

In the present invention, the first loop circuit 100 regulates the gate voltage supplied to the main tap, and the second loop circuit 200 regulates the gate voltage supplied to the pre-emphasis tap. Accordingly, impedance matching for the voltage mode driver is performed while pre-emphasis is performed.

It is preferred that the supply voltage for the pre-driver of the main tap, which is regulated by the first loop circuit 100, be regulated to the gate voltage at which the variable resistor 120 and the two NMOS transistors of the first main tap replica 110 have the same resistance value in the first loop circuit 100 to which the selected reference current Is has been applied.

A change in the variable resistor 120 determines the gate voltage of the main tap, and the gate voltage of the pre-emphasis tap is changed in the direction opposite to that of the gate voltage of the main tap via a feedback loop. Accordingly, the weight of a tap may be controlled by the voltage mode driver.

The regulation of the gate voltage by the first loop circuit 100 is performed in such a manner that the first OP amp 130 compares voltage supplied to the variable resistor 120 with voltage supplied to the first main tap replica 110 using a feedback operation and then regulation is performed such that the variable resistor 120 and the two NMOS transistors of the first main tap replica 110 have the same resistance value.

The OP amp 130 is a kind of a differential amplifier that can be used for operation. The OP amp 130 may stably perform several linear or nonlinear operations when some elements attached to the external circuit of the OP amp, such as a resistor, a capacitor, and a diode, are changed.

If the resistance value of the variable resistor 120 of the first loop circuit 100 of the voltage regulator decreases, the supply voltage for the pre-driver of the main tap increases and consequently the gate voltage supplied to the main tap increases.

The second main tap replica 210 is connected to the first main tap replica 110, and has the same resistance value as the first main tap replica 110. The second main tap replica 210 is connected in parallel to the pre-emphasis tap replica 220.

It is preferred that the supply voltage for the pre-driver of the pre-emphasis tap, which is regulated by the second loop circuit 200, be regulated to the gate voltage at which the NMOS transistors of the second main tap replica 210 and the pre-emphasis tap replica 220 have the same resistance value as the second reference resistor Runit2 230 in the second loop circuit 200 to which the reference current Is has been applied.

The regulation of the gate voltage by the second loop circuit 200 is performed in such a manner that the second OP amp 240 compares the voltage supplied to the second main tap replica 210 and the pre-emphasis tap replica 220 with the voltage supplied to a resistor having the same value as the second reference resistor Runit2 230 using a feedback operation and then regulation is performed such that the NMOS transistors of the second main tap replica 210 and the pre-emphasis tap replica 220 have the same resistance value as the second reference resistor Runit2 230. As described above, the second reference resistor Runit2 230 has the same value as the first reference resistor Runit1 310.

As another embodiment, a voltage mode driver using the voltage regulator for impedance matching and pre-emphasis may be taken into consideration.

The voltage mode transmission driver requires a signal having a low swing in order to send data at a high data rate with low power consumption. Meanwhile, the NMOS transistors, forming the voltage mode driver to which low voltage is supplied, function like resistors when they are driven in the triode region.

Accordingly, in order to determine supply voltage for the voltage mode driver, a voltage regulator should be used.

When a voltage mode driver is configured using the above-described voltage regulator, not only impedance matching but also pre-emphasis can be implemented.

In detail, a voltage mode driver according to the present invention includes the above-described voltage regulator for impedance matching and pre-emphasis, one or more main taps, and a plurality of pre-emphasis taps.

The weight of the main tap of the voltage mode driver is controlled using the variable resistor 120 and the first main tap replica 110 of the first loop circuit 100 of the voltage regulator.

The weight of the pre-emphasis tap of the voltage mode driver is controlled using the second main tap replica 210 and the pre-emphasis tap replica 220 of the second loop circuit 200 of the voltage regulator.

In the voltage mode driver, the one or more main taps and the plurality of pre-emphasis taps are connected in parallel, and the total resistance value of the one or more main taps and the plurality of pre-emphasis taps is identical to the resistance value of the reference resistor Runit of the voltage regulator. Here, the reference resistance is the resistance of the first reference resistor Runit1 310 or the second reference resistor Runit1 230.

FIG. 2 shows an embodiment of the voltage mode driver including a single main tap and three pre-emphasis taps, for example.

A method of regulating voltage for impedance matching and pre-emphasis according to the present invention will now be described below. Descriptions of configurations identical to those of the above-described voltage regulator for impedance matching and pre-emphasis will be omitted here, and only core constructions will be chiefly described.

The method of regulating voltage for impedance matching and pre-emphasis according to the present invention basically uses the above-described voltage regulator.

As described above, the voltage regulator includes the first loop circuit 100 configured to regulate supply voltage for the pre-driver of the main tap, the second loop circuit 200 configured to regulate supply voltage for the pre-driver of the pre-emphasis tap, and the driver voltage determination unit 300 configured to include the first reference resistances Runit1 310 and to determine the supply voltage Vd for the voltage mode driver.

Here, the first loop circuit 100 includes the variable resistor 120, the first main tap replica 110, and the first OP amp 130. The second loop circuit 200 includes the second reference resistor Runit2 230 having the same value as the first reference resistor Runit1 310 of the voltage regulator, the second main tap replica 210, the pre-emphasis tap replica 220, and the second OP amp 240.

Furthermore, each of the first main tap replica 110, the second main tap replica 210, and the pre-emphasis tap replica 220 includes two NMOS transistors.

The method of regulating voltage for impedance matching and pre-emphasis according to the present invention includes step S1 of the driver voltage determination unit 300 determining supply voltage for the voltage mode driver by determining the reference current Is and the reference resistance of the first reference resistor Runit1 310, step S2 of the first loop circuit 100 to which the reference current Is determined at step S1 has been applied determining the resistance value of the variable resistor 120, step S3 of the first loop circuit 100 to which the reference current Is determined at step S1 has been applied regulating supply voltage for the pre-driver of the main tap to the gate voltage at which the variable resistor 120 and the two NMOS transistors of the first main tap replica 110 have the same resistance value, and step S4 of, in the state in which the second main tap replica 210 and the pre-emphasis tap replica 220 of the second loop circuit 200 to which the reference current Is determined at step S1 has been applied are connected in parallel, the second loop circuit 200 regulating the supply voltage for the pre-driver of the pre-emphasis tap to the gate voltage at which the total resistance value of the pre-emphasis tap replica 220 and the second main tap replica 210 to which the gate voltage determined at step S3 has been applied is the same as the resistance value of the first reference resistor Runit1 310 or the second reference resistor Runit2 230.

It is preferred that the resistance value of the variable resistor 120 at step S2 according to the present invention be determined using a parallel switch. The resistance value of the variable resistor 120 can be easily determined externally under the control of the parallel switch.

At step S3 according to the present invention, the first OP amp 130 compares the voltage supplied to the variable resistor 120 with the voltage supplied to the first main tap replica 110 using a feedback operation and regulation is performed to reach the gate voltage at which the variable resistor 120 and the two NMOS transistors of the first main tap replica have the same resistance value.

At step S4 according to the present invention, the second OP amp 240 compares the voltage supplied to the second main tap replica 210 and the pre-emphasis tap replica 220 with voltage supplied to a resistor having the same value as the second reference resistor Runit2 230 using a feedback operation and regulation is performed to reach the gate voltage at which the total resistance value of all the NMOS transistors of the second main tap replica 210 and the pre-emphasis tap replica 220 has the same resistance value as the resistance value of the second reference resistor Runit2 230.

As yet another embodiment of the present invention, a voltage mode driver using the above-described method of regulating voltage for impedance matching and pre-emphasis may be taken into consideration.

The voltage mode driver includes the voltage regulator for driving the method of regulating voltage for impedance matching and pre-emphasis, one or more main taps, and a plurality of pre-emphasis taps. Since the configuration of each of the elements is the same as that of the above-described voltage mode driver, detailed descriptions thereof will be omitted here.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The description of numerals and symbols in the figures is as follows.

| | |
|---|---|
| 100: First loop circuit | 110: First main tap replica |
| 120: Variable resistor | 130: First OP amp |
| 200: Second loop circuit | 210: Second main tap replica |
| 220: Pre-emphasis tap replica | 230: Second reference resistor |
| 240: Second OP amp | |
| 300: Driver voltage determination unit | |
| 310: First reference resistor | |

1. A voltage regulator of a voltage mode driver, comprising:
a first loop circuit configured to regulate a supply voltage for a pre-driver of a main tap;
a second loop circuit configured to regulate a supply voltage for a pre-driver of a pre-emphasis tap; and
a driver voltage determination unit configured to include a reference resistor Runit and to determine supply voltage Vd for the voltage mode driver;
wherein the first loop circuit comprises a variable resistor, a first main tap replica, and a first OP amp, and the second loop circuit comprises a resistor having a resistance value identical to that of the reference resistor Runit of the voltage regulator, a second main tap replica, a pre-emphasis tap replica, and a second OP amp;
wherein each of the first main tap replica, the second main tap replica, and the pre-emphasis tap replica comprises two NMOS transistors.

2. The voltage regulator as set forth in claim 1, wherein the driver voltage determination unit selects a reference current Is expressed by the following Equation:
$${I}_{s} = \frac{{V}_{d}}{{R}_{unit}}$$
in order to regulate the supply voltage Vd.

3. The voltage regulator as set forth in claim 2, wherein the supply voltage for the pre-driver of the main tap, which is regulated by the first loop circuit, is regulated to a gate voltage at which the variable resistor and the two NMOS transistors of the first main tap replica have an identical resistance value in the first loop circuit to which the selected reference current Is has been applied.

4. The voltage regulator as set forth in claim 3, wherein the regulation to the gate voltage is performed in such a way that the first OP amp compares voltage supplied to the variable resistor with voltage supplied to the first main tap replica using a feedback operation and then regulation is performed such that the variable resistor and the two NMOS transistors of the first main tap replica have the identical resistance value.

5. The voltage regulator as set forth in claim 1, wherein when the resistance value of the variable resistor decreases, the supply voltage for the pre-driver of the main tap increases and conductance of the first main tap replica increases.

6. The voltage regulator as set forth in claim 2, wherein the second main tap replica is connected to the first main tap replica and has a resistance value identical to that of the first main tap replica, and the second main tap replica and the pre-emphasis tap replica are connected in parallel.

7. The voltage regulator as set forth in claim 6, wherein the supply voltage for the pre-driver of the pre-emphasis tap, which is regulated by the second loop circuit, is regulated to a gate voltage at which the NMOS transistors of the second main tap replica and the pre-emphasis tap replica have a resistance value identical to that of the reference resistor Runit in the second loop circuit to which the selected reference current Is has been applied.

8. The voltage regulator as set forth in claim 7, wherein the gate voltage is regulated in such a way that the second OP amp compares voltage supplied to the second main tap replica and the pre-emphasis tap replica with voltage supplied to a resistor having a resistance value identical to the reference resistor Runit using a feedback operation of and then regulation is performed such that the NMOS transistors of the second main tap replica and the pre-emphasis tap replica have a resistance value identical to that of the reference resistor Runit.

9. A voltage mode driver including a voltage regulator, comprising:
the voltage regulator for impedance matching and pre-emphasis, set forth in claim 1;
at least one main tap; and
a plurality of pre-emphasis taps.

10. The voltage mode driver as set forth in claim 9, wherein a weight of the main tap is controlled using a variable resistor and a first main tap replica of a first loop circuit.

11. The voltage mode driver as set forth in claim 9, wherein the second loop circuit controls a weight of the pre-emphasis tap using a second main tap replica and a pre-emphasis tap replica.

12. The voltage mode driver as set forth in claim 9, wherein the at least one main tap and the plurality of pre-emphasis taps are connected in parallel, and a total resistance value of the at least one main tap and the plurality of pre-emphasis taps is identical to a resistance value of a reference resistor Runit of the voltage regulator.

13. A method for impedance matching and pre-emphasis of a voltage mode driver using a voltage regulator set forth in claim 1, comprising:
step S1 of the voltage regulator determining supply voltage for the voltage mode driver by determining a reference current Is and a reference resistance of a reference resistor Runit;
step S2 of a first loop circuit to which the reference current Is determined at step S1 has been applied determining a resistance value of a variable resistor;
step S3 of the first loop circuit to which the reference current Is determined at step S1 has been applied regulating supply voltage for a pre-driver of a main tap to a gate voltage at which the variable resistor and two NMOS transistors of a first main tap replica have an identical resistance value; and
step S4 of, in a state in which a second main tap replica and a pre-emphasis tap replica of a second loop circuit are connected in parallel, the second loop circuit to which the reference current Is determined at step S1 has been applied regulating supply voltage for a pre-driver of a pre-emphasis tap to a gate voltage at which a total resistance value of the pre-emphasis tap replica and the second main tap replica to which the gate voltage determined at step S3 has been applied is identical to the resistance value of the reference resistor Runit.

14. The method as set forth in claim 13, wherein the resistance value of the variable resistor at step S2 is determined using a parallel switch.

15. The method as set forth in claim 13, wherein step S3 comprises a first OP amp comparing voltage supplied to the variable resistor with voltage supplied to a first main tap replica using a feedback operation and then regulation being performed to reach the gate voltage at which the variable resistor and two NMOS transistors of the first main tap replica have an identical resistance value.

16. The method as set forth in claim 13, wherein step S4 comprises a second OP amp comparing voltage supplied to the second main tap replica and the pre-emphasis tap replica with voltage supplied to a resistor having a resistance value identical to that of the reference resistor Runit using a feedback operation and then regulation being performed to reach the gate voltage at which the total resistance value of all NMOS transistors of the second main tap replica and the pre-emphasis tap replica is identical to the resistance value of the reference resistor Runit.

17. A voltage mode driver including a voltage regulator, comprising:
the voltage regulator for performing the method of regulating voltage for impedance matching and pre-emphasis, set forth in claim 13;
at least one main tap; and
a plurality of pre-emphasis taps.

18. The voltage mode driver as set forth in claim 17, wherein a weight of the main tap is controlled using a variable resistor and a first main tap replica of the first loop circuit.

19. The voltage mode driver as set forth in claim 17, wherein the second loop circuit controls a weight of the pre-emphasis tap using a second main tap replica and a pre-emphasis tap replica.

20. The voltage mode driver as set forth in claim 17, wherein the at least one main tap and the plurality of pre-emphasis taps are connected in parallel, and a total resistance value of the at least one main tap and the plurality of pre-emphasis taps is identical to a resistance value of a reference resistor Runit of the voltage regulator.
